(19) United States
(12) Patent Application Publication
(10) Pub. No.: US 2021/0256586 A1
(43) Pub. Date: Aug. 19, 2021

(54) METHOD FOR CONSUMERS TO PURCHASE TAILOR-MADE CLOTHING, SHOES OR HATS ONLINE

(71) Applicant: Tongming Lu, Hangzhou (CN)

(72) Inventor: Tongming Lu, Hangzhou (CN)

(21) Appl. No.: 17/306,909

(22) Filed: May 3, 2021

Related U.S. Application Data
(63) Continuation of application No. PCT/CN2018/111349, filed on Oct. 16, 2019.

(30) Foreign Application Priority Data
Nov. 3, 2018 (CN) 201811351106.0

(51) Int. Cl. G06Q 30/06; G06F 3/0484

(52) U.S. Cl. CPC G06Q 30/0621; G06F 3/04842; G06Q 30/0641

(57) ABSTRACT

A method for consumers to purchase tailor-made clothing, shoes or hats online, the method including: the e-commerce website creates personal size customization route on the interface of clothing, shoes, and hats products; authorizing institutions or professionals measure various categories of clothing, shoes and hats as personal size parameters, input the measured personal size parameter values on the e-commerce website or third-party website as the personal size customization parameter information of the product. After the personal size customization parameter information is confirmed correct, and an order is placed, all the personal size customization parameters are attached to the order record on e-commerce website. The supplier or e-commerce website extracts the personal size customization parameters from the order record and obtains the personal size customization parameters origin from e-commerce website individually or in batches to collect, match, divide size, produce the final products.

### CROSS-REFERENCE TO RELATED APPLICATIONS

The present application is a continuation of PCT Patent Application No. PCT/CN2019/111349, entitled “Clothes, Shoe or Hat Customization Method for Consumer During Online Shopping” filed on Oct. 16, 2019, which claims the priority of Chinese Patent Application No. CN201811351106.0 filed on Nov. 3, 2018, all of which are incorporated by reference in their entireties for all purpose.

### FIELD

The present application relates to a method for consumers to purchase tailor-made Clothing, shoes and hats on the Internet, more specifically, for consumers in e-commerce on the website, you can purchase tailor-made Clothing, shoes and hats according to your body specifications.

### BACKGROUND

With the rapid development of e-commerce today, online shopping has become one of the main shopping methods for consumers. Clothing, shoes and hats cover all parts of the human body and are products that are closely related to the size of each part of the human body. Only when the style and size meet the needs of consumers the deal can be finished successfully. Due to the uniqueness of each individual's figure, there is a deviation between personal body size and the national standard or the fixed size of the merchant. How to enable consumers to purchase tailor-made products on the Internet according to their own body specifications has become a technical problem to be overcome by related clothing brands and e-commerce websites.

### SUMMARY

According to a first aspect of the present disclosure, a method for consumers to purchase tailor-made clothing, shoes, and hats online is provided. The method includes: creating, by an e-commerce website, personal size customization route on the interface of clothing, shoes, and hats products; authorizing, by users, institutions or professionals to measure a plurality of categories of clothing, shoes and hats as user's personal size parameters; inputting the measured personal size parameter values on the e-commerce website or third-party website as the user's personal size customization parameter information of the product; confirming, by the user, that the personal size customization parameter information is correct, and placing an order, wherein all the personal size customization parameters are attached to the order record on e-commerce website; extracting, by a supplier or the e-commerce website the personal size customization parameters from the order record individually or in batches; and obtaining, by the e-commerce website, supplier or manufacturer, the personal size customization parameters origin from e-commerce website individually or in batches, collect, match, divide size, produce the final products, and deliver it to the users.

### BRIEF DESCRIPTION OF THE DRAWINGS

FIG. 1 is a flowchart illustrating an exemplary process of purchasing tailor-made clothing, shoes or hats online in accordance with some examples of the present disclosure.

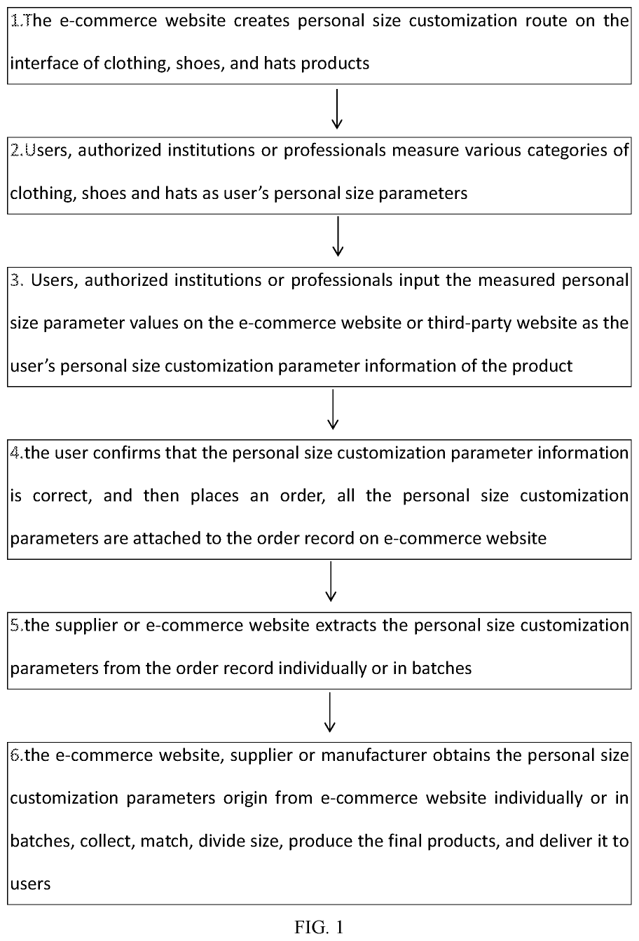

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein may be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

As used herein, the term “if” or “when” may be understood to mean “upon” or “in response to” depending on the context. These terms, if appear in a claim, may not indicate that the relevant limitations or features are conditional or optional.

E-commerce websites generally refer to various e-commerce websites such as various enterprise websites, e-commerce malls, cloud enterprises, and cloud malls that provide trading services based on the Internet. The specific implementation steps are as follows:

1. The e-commerce website creates personal size customization route on the interface of clothing, shoes, and hats products.

Clothing, shoes and hats on existing e-commerce websites are all fixed sizes, which cannot be tailored to consumers' personal sizes. In order to achieve consumer personal size customization, e-commerce websites must break the existing fixed size model and create personal size customization route for clothing, shoes and hats production.

(1) The e-commerce website creates personal size customization route on the interface of clothing, shoes, and hats products.

There are four modes to create the user's personal size customization routes on the e-commerce website as follows. The manual e-commerce website does not need to establish a personal size customization database for each category of Clothing, shoes and hats in mode one and mode two; in mode three, the e-commerce website needs to establish a personal size customization database for each category of clothing, shoes and hats; in mode four, the e-commerce website does not build each category, and the personal size customization database of Clothing, shoes and hats is established by a third-party website.

Mode 1

The e-commerce website creates a new selection box (non-fixed size) in the “Size” column of the clothing, shoes, and hats interface. When a user clicks the selection box when shopping online, the dialog box displays the personal size parameters of the product. If there is only one selection box in the “Size” column of the product, it means that this product only accepts personal size customization; if there are addition of selection boxes and the fixed size of the existing product (such as clothing: XS/S/M/L/XL; shoes: 35/36/37/38/39/40/41/; Hat: 55/56/57/58/59/60/61), it means that this style product accepts both fixed size orders and personal size custom orders.

Mode 2

The e-commerce website adds a personal size information column option in the “Size” column of the clothing, shoes, and hats products interface to display the product's personal size parameter information. If there is only a personal size information column in the “Size” column of the product interface, it means that this product only accepts personal size customization; if there are addition of a personal size information column option and the fixed size of the existing product (such as clothing: XS/S/M/L/XL; shoes: 35/36/37/38/39/40/41/; Hat: 55/56/57/58/59/60/61), it means that this style product accepts both fixed size orders and personal size custom orders.

Mode 3

E-commerce website establishes a continuously updated database of personal size information for various categories of Clothing, shoes and hats, and opens a new selection box (non-fixed size) in the “size” column of the Clothing, shoes and hats interface, and users shop online when you click the selection box, it will automatically connect to the website's internal personal size information database, and the personal size parameters will be displayed in the dialog box. If there is only one check box in the “Size” column, it means that this product only accepts personal size customization orders; if there are addition of selection boxes and the fixed size of the existing product (such as clothing: XS/S/M/L/XL; shoes: 35/36/37/38/39/40/41/; Hat: 55/56/57/58/59/60/61), it means this style product accepts both fixed-size orders and personal-size customization orders.

Mode four.

The third-party websites establish a continuously updated database of personal size information for specific parts of various categories of clothing, shoes, and hats. The new e-commerce website opens an agreement to open a selection box (non-fixed size) that can connect to third-party websites, and users shop online when you log in to any e-commerce website that has opened a size customization service with a third-party website, click the new option box, and a dialog box will pop up. After entering the account and password registered on the third-party website, request the third-party server to extract the user's personal size Parameter data. After the third-party website server receives the instruction and passes the verification, the user's personal size customization parameter data will be fed back to the e-commerce website, and the personal size customization parameters will be displayed in the dialog box for the user to confirm the size customization information.

If there is only one check box in the “Size” column, it means that this product only accepts personal size customization orders; adding selection box based on the fixed size of product (such as clothing: XS/S/M/L/XL; shoes: 35/36/37/38/39/40/41/; Hat: 55/56/57/58/59/60/61) it means that the style accepts both fixed-size orders and personal size custom orders.

The personal size information of clothing, shoes and hats is composed of human body parts or the information of each category of Clothing, shoes and hats.

The information of human body parts includes the height, weight, neck width, shoulder width, underarm back width, chest width, waist width, upper body length, hand length, arm width, hip width, thigh width, calf width, ankle foot width, leg length, Human body parts such as file length, foot length, foot width, and head width.

The Information of clothing, shoes, and hat parts include chest width, body length, back width, shoulder width, collar width, sleeve length, cuff width, hem width, waist width, pants length, hip width, front rise length, back rise length, and foot bottom width, shoe width, shoe length, hat width, etc., the information of various clothing, shoes, hat parts can be adjusted according to specification of styles.

There are the personal size customization parameters for each category of clothing, shoes and hats. For example: parameters of hat: include height and head width; parameters of shoe include weight, height, foot length and foot width; Parameters of T-shirts, shirts, cultural shirts, jackets, hoodies, suits and down jackets include weight, height, bust, length, shoulder width, collar width, sleeve length and hem width. Parameters of windbreaker and dress include weight, height, chest width, dress length, waist width, hip width, collar width, shoulder width and sleeve length; parameters of trouser such as trousers, casual pants, jeans, etc. Include weight, height, waist width, trouser length, hip width, front rise length, back rise length, and foot bottom width. If there are new categories of clothing, shoes and hats, the personal size parameters can be adjusted according to the requirements of the brand or user.

Third-party website, professionally provide personal size customization data services for various categories of clothing, shoes and hats. The third-party website has a database of personal size parameter information for various categories of Clothing, shoes and hats, user registration ID and password, and stores user personal size parameter information of various categories of clothing, shoes and hats, and agreement is connected to various e-commerce website to open personal size customized functions for products of clothing, shoes and hats; when a user is shopping on the e-commerce website, he clicks a new selection box (non-fixed size) in the “Size” column of interface of the clothing, shoes, and hat products, and a dialog box pops up to use the account and of the third-party website, Log in with a password, connect to the personal size information database of the third-party website, the personal size parameters of the third-party website will be displayed in the “Size” dialog box of the product on the e-commerce website, the user only needs to use the personal size customized information database in a third-party website to purchase the products of personal size customization in e-commerce website in the world with any agreement to open customized services.

Users can freely use personal size customization parameters according to their preferences to purchase the same category products of different brands on different websites. Personal size customization information storing the 3^{rd} party website is common to be used by all e-commerce websites or stores with agreement deal in the world, it breaks through the limitation of single-use data by traditional one-to-one customized service merchants.

The third-party website and the e-commerce website have the same product category and name to avoid confusion or errors of identification.

2. Users, authorized institutions or professionals measure various categories of clothing, shoes and hats as user's personal size parameters.

(1) Selection of Standard Samples of Various Categories of Clothing, Shoes and Hats.

Specifically, shoes, hats, underwear, socks and other categories are directly attached to the body, and the parameters of related parts of the human body can be directly used as personal size customization parameters.

Other categories of clothing such as T-shirts, shirts, cultural shirts, jackets, hoodies, suits, down jackets, windbreakers, dresses, trousers, casual pants, jeans etc., according to the user's clothing style habits, the user can use the most suitable Clothing, shoes and hats of the same category as the standard samples of the category.

(2) Measurement of Personal Size Parameters for the Standard Samples of User.

Users can measure their own body parts or standard samples to obtain personal size parameters; allow professional institutions or professionals to measure user body parts or standard samples to obtain personal size parameters; allow professional institutions or professionals to directly measure the specification of the human body to obtain the personal size parameters of categories of clothing, shoes, and hats; or use external equipment such as 3D human body scanning to collect data to obtain personal size parameters.

The user, authorized institution or professional input the measured personal size parameter values on the e-commerce website or third-party website as the user's personal size customization parameter information of the product.

The user, authorized institution or person inputs the user's personal size customization parameter information for the product.

A. For Mode 1, the user or authorized institution clicks on the “Size” column to open a new selection box (not fixed size), the personal size information dialog box will pop up, and directly inputs the value of the personal size parameter in the window as the personal size customization parameter Information;

For Mode 2, the user or authorized institution directly inputs the value of the personal size parameter in the personal size information column under the “Size” column, as the personal size customization parameter information;

For Mode 3, the user, authorized institution or professional logs in the personal size information database of each category of clothing, shoes and hats on the e-commerce website, and input the personal size customization parameter information for specific styles.

When users make online purchases on the e-commerce website, click on the “Size” column in the interface of clothing, shoes, and hat products to create a new item, select the box (non-fixed size) to automatically connect to the database of personal size customization information stored in the website, and display the user's personal size customization parameter information in the dialog box.

For mode four, users, authorized institutions or professionals log in to the personal size information database of various categories of clothing, shoes and hats on third-party websites, and input the personal size customization parameter information for specific styles.

When users log in e-commerce website to link an agreement with the third-party website for size customization service, click the non-fixed size selection box that can connect to external websites, and the dialog box will pop up; after entering the account and password registered on the third-party website, request the third-party server to extract the user's personal size customization parameter data, the third-party website server is receiving the instruction; after the verification is passed, the user's personal size customization parameter data will be fed back to the e-commerce website, and the personal size customization parameters will be displayed in the dialog box, which is convenient for the user to confirm the size customization information.

(2) Personal Size Customization Parameter Information can be Periodically Corrected and Adjusted According to Changes of Human Growth.

Human body is a dynamic development, and body parts is growing with the development of the human body. Therefore, the personal size customization data of various categories of Clothing, shoes and hats can be dynamically adjusted with the development of the user's body, and the user can adjust the data of body part according to the body changes. It can also allow professional institutions or professionals to help user to adjust the data of personal size customization to ensure that the personal size customization data of the specific style fit user well after correction and adjustment.

4. The user confirms that the personal size customization parameter information is correct, and then places an order, all the personal size customization parameters are attached to the order record on e-commerce website.

The user is using the personal size parameter to purchase a tailor-made product before placing an order on e-commerce website, the personal size customization parameter information of product needs to be confirmed by the user. Once the user confirms the personal size customization parameter information is correct, the personal size customization parameter is merged into character string that is directly used as the name of the order product or as a customized data item of the order record.

This personal size customization parameter is merged into a character string. For example, the personal size customization parameter of a user's jeans: weight 75; height 175; waist width 80; pants length 102; hip width 92; front rise length 20; back rise length 25; foot bottom width 15 (weight KG, length CM). the user confirms that the 8 personal size customization parameters of the jeans are correct, places the order, and the 8 personal size customization parameters of jeans are merged into a character string: jeans_weight_75_height_175_waist width_80_pants length_102_hip width_92_front rise length_20_back rise length_25_foot bottom width_15 can be directly used as the order product name or order record custom data item.

The character string manual for other categories of clothing, shoes, hats personal size customization parameters are merged into a character string directly as the order name of products: hat_value_height_value_head-width_value; shoes_weight_value_height_value_foot-length_value_foot-width_value; T-shirt, shirt, T-shirts, jackets, hoodies, suits, down jackets_weight_value_height_value_chest-width_value_length_value_shoulder-width_value_neck-width_value_sleeve-length_value_bottom-width_value; West-Pants, casual-pants, jeans_weight_value_height_value_waist_value_pants-length_value_hip-width_value_front-rise length_value_back-rise length_value_foot bottom width_value.

The body part, category or sequence position in the character string can be increased or decreased and adjusted according to the specific clothing.

The supplier or e-commerce website extracts the personal size customization parameters from the order record individually or in batches.

The supplier or e-commerce website extracts the personal size customization parameters from the order record individually or in batches. Specifically, it extracts a personal size customization parameter of the style for each user from character string in each of order name of product or order record customization data item individually or in batches.

For example, the order for jeans containing the character string (jeans_weight_75_height_175_waist width_80_pants length_102_hip width_92_front rise length_20_back rise length_25_foot bottom width_15), it is very easy for a supplier or e-commerce company to parse the character string content in a certain format and extract the personal size customization parameters of jeans as follows: Jeans, weight 75; height 175; waist width 80; pants length 102; hips width 92; front rise length 20; back rise length 25; foot bottom width 15.

Suppliers, e-commerce websites or manufacturers extract personal size customization parameters from massive online shopping orders to prepare for large-scale industrial production based on personal size customization.

The e-commerce website, supplier or manufacturer obtains the personal size customization parameters origin from e-commerce website individually or in batches, collect, match, divide size, produce the final products, and deliver it to users.

Commerce websites, suppliers or manufacturers collect a large amount of personal size customization parameter information, it matches that each size specification of the personal size customization orders is consistent with the fixed size production, first deliver it to users, and then produce the others products according to the personal size customization parameter, finally deliver to users.

The number of personal size parameters for shoes and hats is relatively small, which is suitable for collecting batch personal size customization parameters and matching each size specification of personal size customization product with fixed size product stock, and then produce the others tailor-made orders.

Clothing is also suitable to collect the batch personal size parameters, first match each size specification of personal size customization product with fixed size product stock, and then produce the remaining tailor-made orders through dividing the size and accurately repairing the piece according to each personal size parameters. It realizes personal tailor-made clothing based on precise demand and industrialized mass production. Through the above invented methods, consumers can easily purchase the tailor-made Clothing, shoes and hats online shopping.

This manual ignores the normal technical processes of the existing online shopping on e-commerce website, and does not describe it the common details (for example: Register personal ID, password, bank account, deliver address; login the e-commerce website; browse interface of product; place the order; pay money online and receive the Logistics information etc.). It focuses the innovative content related to purchase the tailor-made product of clothing, shoes and hats online shopping. Please understand it.

At present, there is an obvious problem that consumers can only purchase fixed-size clothing, shoes and hats in e-commerce websites, but fixed-size products may not fit properly, resulting in frequent returns and exchanges the production, even the deals are canceled frequently. In view of the above drawback, the present application provides online shopping consumers with a method for purchasing tailor-made clothing, shoes and caps according to their body specifications, and solves the problem of the fit of consumers' online shopping of clothing, shoes and caps.

Consumers buy online tailor-made technical solutions for Clothing, shoes and hats according to their body specifications.

(1) The e-Commerce Website Creates Personal Size Customization Route on the Interface of Clothing, Shoes, and Hats Products.

Users, authorized institutions or professionals measure various categories of clothing, shoes and hats as user's personal size parameters.

The user, authorized institution or professional input the measured personal size parameter values on the e-commerce website or third-party website as the user's personal size customization parameter information of the product.

The user confirms that the personal size customization parameter information is correct, and then places an order, all the personal size customization parameters are attached to the order record on e-commerce website.

The supplier or e-commerce website extracts the personal size customization parameters from the order record individually or in batches.

The e-commerce website, supplier or manufacturer obtains the personal size customization parameters origin from e-commerce website individually or in batches, collect, match, divide size, produce the final products, and deliver it to users.

The application realizes that consumers can place tailor-made orders according to their own body specification when shopping online for clothing, shoes and hats, overcomes the problem that consumers often buy unfit clothing, shoes, and hats online, and is extremely convenient for consumers shop online according to their body specification, saving a lot of shopping time and cost. Brands of clothing, shoes and hats can accurately produce according to the precise needs of customers, realize large-scale industrial production based on individualization effectively, control and reduce product inventory, and avoid a large number of waste of labor and logistics costs caused by returns and exchanges because of improper products. For e-commerce website, it provides consumers with diversified services that meet their needs, which not only improves the success rate of online transactions, but also enhances consumers' satisfaction with online shopping.

The description of the present disclosure has been presented for purposes of illustration, and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described in order to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for consumers to purchase tailor-made clothing, shoes, and hats online, comprising:
creating, by an e-commerce website, personal size customization route on the interface of clothing, shoes, and hats products;
authorizing institutions or professionals to measure a plurality of categories of clothing, shoes and hats as personal size parameters,
inputting the measured personal size parameter values on the e-commerce website or third-party website as the personal size customization parameter information of the product;
confirming, by the user, that the personal size customization parameter information is correct, and placing an order, wherein all the personal size customization parameters are attached to the order record on e-commerce website;
extracting, by a supplier or the e-commerce website the personal size customization parameters from the order record individually or in batches; and
obtaining, by the e-commerce website, supplier or manufacturer, the personal size customization parameters origin from e-commerce website individually or in batches to collect, match, divide size, produce the final products, and deliver it to the users.

2. The method according to claim 1, wherein the e-commerce website creates personal size customization route on the interface of clothing, shoes, and hats products, and the e-commerce website is new in the “Size” column one the interface of clothing, shoes, and hats product; and
the method further comprises:
opening the selection box, and clicking the selection box, by the users, when shopping online, wherein the dialog box displays the personal size parameters of the product;
if only one selection box is displayed in the product “size” column, the product only accepts personal size customization; and
adding a selection box based on the fixed size of product means that this style accepts both fixed-size orders and personal-size custom orders.

3. The method according to claim 1, wherein the e-commerce website creates the personal size customization route on the interface of clothing, shoes, and hats products and the e-commerce website has a new “Size” column in the clothing, shoes, and hats product interface; and
wherein the option of personal size information column displays the personal size parameter information of the product; if there is only a personal size information column in the “Size” column of the product interface, this product only accepts personal size customization; adding a new personal size information bar option based on the fixed size of product means that the style accepts both fixed size orders and personal size custom orders.

4. The method according to claim 1, wherein the e-commerce website creates personal size customization route on the interface of clothing, shoes, and hats products, and the e-commerce website establishes continuously updated Information database of personal size customization for each category of clothing, shoes, and hats; and
wherein a new selection box is created in the “Size” column of the clothing, shoes, and hats products interface, and the user clicks the selection box when shopping online to automatically connect to the website's internal personal size information database, and the personal size parameters will be displayed in the dialog box; if there is only one selection box in the “Size” column, this product only accepts personal size customization orders; adding a selection box on the fixed size of product means that the style accepts both fixed size orders and personal size customization orders.

5. The method according to claim 1, wherein the e-commerce website creates personal size customization route on the clothing, shoes, and hats products interface, and the third-party website establishes the information database of personal size customization that is continuously updated for the specification of each category of clothing, shoes, and hats, e-commerce website makes agreement with third-party websites to open a selection box that can connect to third-party websites, when users log in to any e-commerce website that has agreement with a third-party website to create a size customization service when shopping online, click on the newly opened selection box, and the dialogue will pop up Box, enter the account and password registered on the third-party website, request the third-party server to extract the personal size customization parameter data, passes the verification after the third-party website server receives the instruction and the personal size customization parameter data is fed back to the e-commence website, the personal size customization parameters will be displayed in the dialog box, which is convenient for users to confirm the size customization information; if there is only one selection box in the “Size” column, this product only accepts personal size customization orders; adding selection box based on the fixed size of product means that the style accepts both fixed-size orders and personal size custom orders.

6. The method according to claim 1, wherein to establish a database of personal size parameter information of various categories of clothing, shoes, and hats on a third party website, the third party website stores user personal size parameter information of various categories of clothing, shoes, and hats, and the agreement is connected to each e-commerce website that creates the tailor-made function for clothing, shoes, and hats, the users use the personal customization information of a third-party website to login any e-commerce website that is an agreement to create a personal size customized in the world.

7. The method according to claim 1, wherein the users use the personal customization information of a third-party website to login any e-commerce website that is an agreement to create a personal size customized in the world, the user logins e-commerce website with a agreement to create a personal size customized in the world, the e-commerce website uses a database that stores personal size customized information from a third-party website, the users use personal size customization parameters to purchase products of the same category from different brands on different websites according to their preferences, wherein personal size customization information is common to all agreed e-commerce sites worldwide.

8. The method according to claim 1, wherein all the personal size customization parameters are appended to the order record, and the personal size customization parameters are merged into a character string directly in the name of the order product or as a customized data item in the order record.

9. The method according to claim 1, wherein the personal size customization parameters are merged into a character string directly as the order product name or as an order record customization data item, and the personal size customization parameters for each category of clothing, shoes, and hats are merged into a character string directly in the name of the order product: hat_value_height_value_head-width_value; shoes_weight_value_height_value_foot-length_value_foot-width_value; T-shirt, shirt, Cultural shirts, jackets, hoodies, suits, down jackets_weight_value_height_value_chest-width_value_length_value_shoulder-width_value_neck-width_value_sleeve-length_value_bottom-width_value; West-Pants, casual-pants, jeans_weight_value_height_value_waist_value_pants-length_value_hip-width_value_front-rise length_value_back-rise length_value_foot bottom width_value.

10. The method according to claim 1, wherein the supplier or e-commerce website extracts the personal size customization parameters from the order record individually or in batches, and the supplier or e-commerce website extracts the personal size customization parameters of the style from character string in each order name of product or order record customization data item individually or in batches.

11. The method according to claim 1, wherein the e-commerce website, the supplier or manufacturer collects a large amount of personal size customization parameter information, matches each specification between the personal size and fixed size, priority deliver the personal size product with same specifications from fixed product to the user, and then divides the size by personal size customization parameter, produces the product of personal size customization, and delivers the personal size product to the user.

12. The method according to claim 1, wherein when the number of personal size parameters for shoes and hats is less than a preset threshold, the e-commerce website, the supplier or manufacturer collects batch personal size customization parameters, match each specification with the existing fixed size product, and then deliver the personal size shoes and hats with same specifications from fixed product to the user, finally produce the shoes and hats of the tailor-made orders.

13. The method according to claim 1, further comprising:
collecting batch personal size parameters first, matching each specification between the personal size and fixed size product, and then precise cutting the piece of clothing, producing, finally producing other tailor-made orders; and
finishing tailor-made clothing based on precise demand for industrialized mass production.
